(19) United States
(12) Patent Application Publication
(10) Pub. No.: US 2025/0021825 A1
(43) Pub. Date: Jan. 16, 2025

(54) FEDERATED LEARNING CONTRIBUTION CALCULATION METHOD AND FEDERATED LEARNING CONTRIBUTION CALCULATION AND PROFIT-SHARING SYSTEM

(71) Applicant: METATECH (AP) INC., New Taipei City (TW)

(72) Inventors: YING-CHEN YANG, New Taipei City (TW); TZU-LUNG SUN, New Taipei City (TW); YEONG-SUNG LIN, Taipei (TW); TSUNG-CHI CHEN, New Taipei City (TW)

(21) Appl. No.: 18/765,368

(22) Filed: Jul. 8, 2024

Related U.S. Application Data
(60) Provisional application No. 63/525,786, filed on Jul. 10, 2023.

(51) Int. Cl. G06N 3/098

(52) U.S. Cl. CPC G06N 3/098

(57) ABSTRACT

A federated learning contribution calculation method comprises the following steps: a plurality of participants collaboratively developing a federated aggregation model by federated learning method according to their own local datasets; excluding the participation of at least one first participant in all participants, and then the remained participants collaboratively developing a contribution model by federated learning method; and, comparing the value of the first contribution model and the value of the federated model to obtain the contribution of the at least one first participant. The method of the present invention is capable of calculating the contribution(s) of single participant or multiple participants in the federated learning by few additional information and few additional calculations, so as to achieve the fair profit sharing according to the contributions.

### BACKGROUND OF THE INVENTION

### 1. Field of the Invention

The invention relates to a method and system for calculating contributions in federated learning, specifically to a method and system capable of calculating the contributions of individual members within federated learning and a system capable of performing profit-sharing based on the calculated contributions.

### 2. Description of the Prior Art

With the advancement of medical engineering technology, the application of regenerative medicine in clinical disease treatments has become more diverse and increasingly attracts attention from various sectors. Regenerative medicine is primarily applied in organ repair, immune cell therapy, and stem cell therapy. Cell therapy involves using the body's cells, which are cultivated or processed ex vivo before reintroducing into the patient's body. Therefore, effectively cultivating cells is a crucial aspect of regenerative medicine. Previous studies have shown that each individual's cells possess unique characteristics, and the cells must be customized according to individual cases to increase their suitability for treatment, adding complexity and difficulty to the cell production process. With a large amount of cell and bioprocess data available, using machine learning to generate predictive models for assessing cell cultivation conditions and the effect of the process parameters is feasible, thus potentially reducing the complexity and difficulty of customizing cell processes. However, the cell and bioprocess data are often sensitive and private personal data, such as patient cell data from different hospitals or laboratories. The traditional centralized machine learning methods, which require aggregating all bioprocess data on a central server for analysis and training, might not be used or restricted by regulatory, privacy protection, and commercial considerations. Moreover, centralized machine learning methods face similar issues in medical engineering and any field where the data are sensitive and private.

Federated learning, or collaborative learning, is a machine learning technique that involves training algorithms on multiple decentralized edge devices or servers, each possessing local data samples. This method differs significantly from traditional centralized machine learning techniques, where all local data sets are uploaded to a single server for machine learning training. In federated learning, multiple members train their own datasets to produce individually trained models. The trained model parameters are then uploaded to a central server, which assigns weights and aggregates all the trained model parameters to form a federated model. The federated model can then be redistributed to all members for use. Since the central server only aggregates the trained model parameters and does not directly analyze or process the datasets of the members, the sensitive and private data samples within each member's dataset do not get exposed, thus maintaining data confidentiality.

Since the federated model generated by federated learning is based on the models individually trained by each member, each member contributes differently to the federated model. If the federated model becomes commercially viable and profitable due to its reliability and predictive accuracy, the members may need to receive a portion of the profits based on their contributions. The members' contributions also represent their effects or influences on the federated model, and it can be used to assess whether the weight given to each member in the federated model is appropriate. However, there is no means for calculating contributions for the members of the federated learning method.

Therefore, it is necessary to develop an efficient method and system to calculate the contribution of each member in federated learning, which can be applied to member profit sharing or other functions based on the contributions.

### SUMMARY OF THE INVENTION

In light of this, the present invention provides a federated learning contribution calculation method in to solve the aforementioned known problems.

According to an embodiment of the present invention, the federated learning contribution calculation method includes the following steps: a central server receiving a plurality of trained model parameters, wherein the trained model parameters are generated by machine learning on a plurality of local datasets; the central server performing an aggregation algorithm on the trained model parameters to generate and store a federated model; the central server performing the aggregation algorithm on the trained model parameters, excluding or simulating to exclude at least one first trained model parameter, to generate a first contribution model; and, the central server comparing the value of the first contribution model with the value of the federated model to generate a contribution of the at least one first trained model parameter.

Wherein, the trained model parameters are generated by multiple machine learning training on the local datasets. The central server performs the aggregation algorithm on the trained model parameters from each machine learning training to generate the federated model, and the central server performs the aggregation algorithm on the trained model parameters, excluding the at least one first trained model parameter from the last machine learning training, to generate the first contribution model.

Wherein, the trained model parameters are generated by multiple machine learning training on the local datasets. The central server performs the aggregation algorithm from each machine learning training to generate the federated model, and the central server performs the aggregation algorithm on the trained model parameters, simulating to exclude the at least one first trained model parameter from each machine learning training to generate the first contribution model.

Wherein, the trained model parameters are generated by multiple machine learning training on the local datasets. The central server performs the aggregation algorithm separately for each machine learning training to generate a corresponding federated model for each machine learning training, and the central server performs the aggregation algorithm on the trained model parameters, excluding the at least one first trained model parameter from each machine learning training, to generate a corresponding first contribution model for each machine learning training. The central server respectively compares the value of each corresponding first contribution model with the value of each corresponding federated model for each machine learning training, and performs an averaging or weighted averaging calculation to generate an average contribution as the contribution of the at least one first trained model parameter.

Wherein, the trained model parameters are generated by multiple machine learning training on the local datasets. The central server performs the aggregation algorithm for each machine learning training to generate the federated model, and the central server performs the aggregation algorithm on the trained model parameters, simulating to exclude the at least one first-trained model parameter from the last to the kth previous machine learning training, to generate the first contribution model, wherein k is an integer between 1 and the number of times the first trained model parameter participated in the aggregation algorithm of the federated model.

Wherein, the federated learning contribution calculation method further includes the following steps: the central server judging whether the contribution of the at least one first trained model parameter is positive or negative; and, if the contribution is negative, the central server replaces the federated model with the first contribution model as an updated federated model.

Additionally, the present invention also provides a federated learning contribution calculation and profit-sharing system, which solves the aforementioned known problems and can be applied to the profit-sharing for the participants in federated learning.

According to an embodiment of the present invention, the federated learning contribution calculation and profit-sharing system includes a plurality of artificial intelligence model training devices and a central server, wherein the central server further includes a computation module, a contribution calculation module, and a profit-sharing module. The artificial intelligence model training devices perform machine learning on a plurality of local datasets to generate a plurality of trained model parameters, and the central server is connected to each of the artificial intelligence model training devices to receive the trained model parameters. The computation module of the central server is configured to perform an aggregation algorithm on the received trained model parameters to generate a federated model. The contribution calculation module is configured to perform the aggregation algorithm to the trained model parameters, excluding or simulating to exclude at least one first trained model parameter to generate a first contribution model, and then configured to compare the value of the first contribution model with the value of the federated model to determine the contribution of the first trained model parameter. The profit-sharing module is connected to the contribution calculation module to receive the contribution of the at least one first trained model parameter and to calculate a profit-sharing ratio for the at least one first trained model parameter in the federated model based on the contribution.

Wherein, the artificial intelligence model training devices respectively perform multiple machine learning trainings on the local datasets. The computation module is configured to perform the aggregation algorithm for each machine learning training to generate the federated model, and the contribution calculation module is configured to perform the aggregation algorithm on the trained model parameters, excluding the at least one first trained model parameter from the last machine learning training, to generate the first contribution model.

Wherein, the artificial intelligence model training devices respectively perform multiple machine learning trainings on the local datasets. The computation module is configured to perform the aggregation algorithm for each machine learning training to generate the federated model, and the contribution calculation module is configured to perform the aggregation algorithm on the trained model parameters, simulating to exclude the at least one first trained model parameter from each machine learning training, to generate the first contribution model.

Wherein, the artificial intelligence model training devices respectively perform multiple machine learning trainings on the local datasets. The computation module is configured to perform the aggregation algorithm for each machine learning training to generate the federated model, and the contribution calculation module is configured to perform the aggregation algorithm on the trained model parameters, simulating to exclude the at least one first trained model parameter from the last to the kth previous machine learning training, to generate the first contribution model, wherein k is an integer between 1 and the number of times the at least one first trained model parameter participated in the aggregation algorithm for the federated model.

Wherein, the artificial intelligence model training devices respectively perform multiple machine learning trainings on the local datasets. The computation module is configured to perform the aggregation algorithm separately for each machine learning training to generate a corresponding federated model for each machine learning training, and the contribution calculation module is configured to perform the aggregation algorithm on the trained model parameters, excluding the at least one first trained model parameter from each machine learning training, to generate a corresponding first contribution model for each machine-learning training, the contribution calculation module is configured to compare the value of each corresponding first contribution model with the value of each corresponding federated model from each machine learning training, and configured to perform averaging or weighted averaging calculation to generate an average contribution as the contribution of the at least one first trained model parameter.

In summary, the federated learning contribution calculation method and system of the present invention can calculate the contributions of the trained model generated by the participants within the federated model so as to achieve fair profit sharing according to the contributions. The model weights of the participants within the federated model can also be adjusted based on their contributions to enhance the accuracy of the federated model generated by federated learning.

The advantages and spirit of the present invention can be further understood by the following detailed description and with reference to the diagrams.

### BRIEF DESCRIPTION OF THE APPENDED DRAWINGS

FIG. 1 is a flowchart diagram illustrating a federated learning contribution calculation method according to an embodiment of the present invention.

FIG. 2 is a schematic diagram illustrating a federated learning contribution calculation and profit-sharing system according to another embodiment of the present invention.

FIG. 3 is a flowchart diagram illustrating a federated learning contribution calculation method according to another embodiment of the present invention.

FIG. 4 is a flowchart diagram illustrating a federated learning contribution calculation method according to another embodiment of the present invention.

FIG. 5 is a flowchart diagram illustrating a federated learning contribution calculation method according to another embodiment of the present invention.

FIG. 6 is a flowchart diagram illustrating a federated learning contribution calculation method according to another embodiment of the present invention.

FIG. 7 is a flowchart diagram illustrating a federated learning contribution calculation method according to an embodiment of the present invention.

FIG. 8 is a flowchart diagram illustrating a federated learning contribution calculation method according to another embodiment of the present invention.

### DETAILED DESCRIPTION OF THE INVENTION

To make this invention's advantages, spirit, and characteristics more accessible and straightforward, detailed explanations and discussions will be provided through specific embodiments, referring to the accompanying diagrams. It is important to note that these particular embodiments merely represent this invention, and the exact methods, devices, conditions, materials, etc., mentioned are not intended to limit the invention or its corresponding specific embodiments. Additionally, the components in the diagrams are used only to express their relative positions and are not drawn to scale. The step numbers used in the description of this invention are for distinguishing different steps and do not represent the order of the steps, which is clarified here for better understanding.

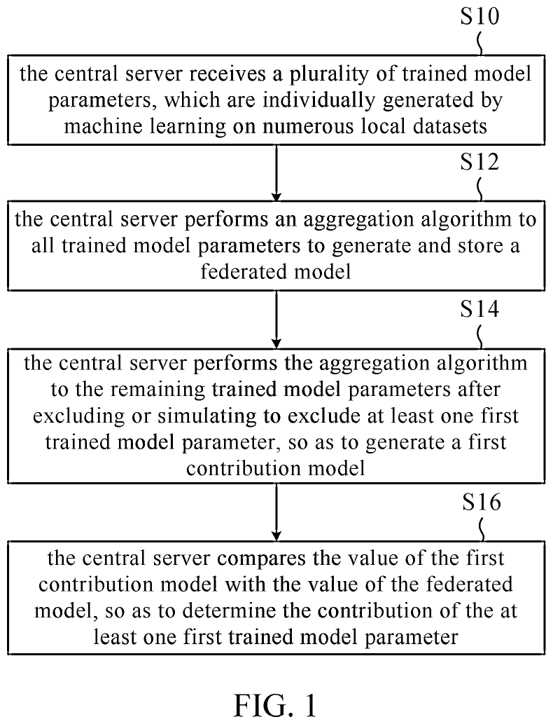

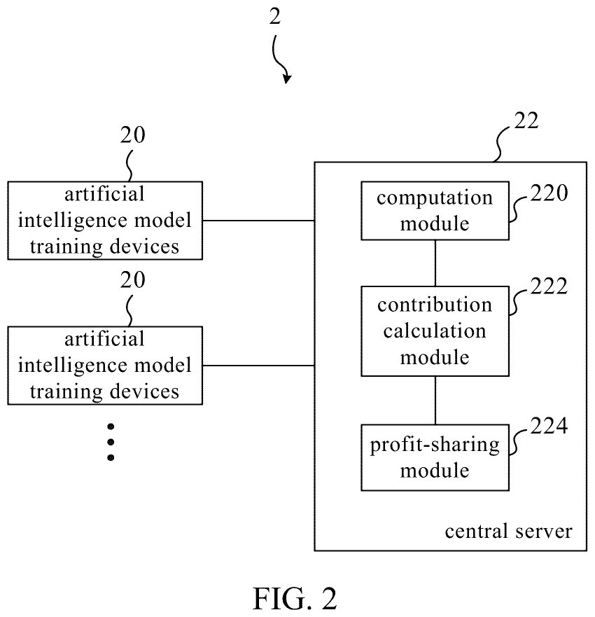

Please refer to FIGS. 1 and 2. FIG. 1 is a flowchart diagram illustrating a federated learning contribution calculation method according to an embodiment of the present invention. FIG. 2 is a schematic diagram illustrating a federated learning contribution calculation and profit-sharing system according to another embodiment of the present invention. It should be noted that the steps of the method shown in FIG. 1 can be executed by different system units of the system shown in FIG. 2. Therefore, the steps shown in FIG. 1 are described through the system depicted in FIG. 2.

As shown in FIG. 2, the federated learning contribution calculation and profit-sharing system 2 of the present embodiment includes multiple artificial intelligence (AI) model training devices 20 and a central server 22 connected to the devices 20. Each AI model training device 20 performs machine learning on its local dataset to generate its own trained model. In practice, the AI model training devices 20 are distributed nodes capable of executing complete machine learning algorithms independently, such as computers in hospitals or laboratories within the regenerative medicine field that perform machine learning algorithms, with the local datasets consisting of training, validation, and testing sample datasets owned by each hospital or laboratory. Each AI model training device 20 can transmit its trained model parameters to the central server. Although only two AI model training devices 20 are shown in FIG. 2, the number of such devices and their trained model parameters in practice is not limited to this embodiment. Any number of AI model training devices and their trained model parameters can be adopted in the present invention. The central server 22 can receive the trained model parameters from these AI model training devices 20 and includes a computation module 220, a contribution calculation module 222, and a profit-sharing module 224, where the contribution calculation module 222 is connected to the computation module 220, and the profit-sharing module 224 is connected to the contribution calculation module 222. In practice, the computation module 220, contribution calculation module 222, and profit-sharing module 224 can be built together in the computing unit of the central server 22, such as a computer or server's central processing unit or computing chip, or they can also be executed separately in different and interconnected computing units.

The computation module 220 can perform an aggregation algorithm to all received trained model parameters to generate a federated model. The actual operation of the aggregation algorithm involves the computation module 220 assigning weights to each trained model parameter before aggregation. Since the aggregation algorithms for federated learning are well-known in the field, they would not be further described here. It should be noted that any aggregation algorithm used to generate a federated model can be applied in this invention. The contribution calculation module 222 can simulate the exclusion of at least one trained model parameter, referred to at least one first trained model parameter, from all trained model parameters. It then performs the same aggregation algorithm to the remaining trained model parameters to obtain a first contribution model. The contribution of the first trained model parameter to the federated model can then be determined by comparing the value of the first contribution model with that of the federated model. Specifically, if the first trained model parameter contributes to the federated model, its removal will result in a depreciation of the first contribution model compared to the federated model. This depreciation can be used to deduce the contribution of the first trained model parameter. The value of the aforementioned first contribution model and the federated model can be calculated through each model's accuracy. For example, a value function can be defined where the value is linearly related to the model's accuracy, and then a higher accuracy of the model indicates a higher value. The value function can be collaboratively determined by all federation members and is not limited to the linear relationship described above.

The profit-sharing module 224 determines the profit-sharing ratio for the AI model training device, which generated the first trained model parameter according to the contribution of the at least one first model parameter or collective contributions. Consequently, when the federated model generates profit, the member owning the AI model training device that generated the first trained model parameter can receive profits according to the determined profit-sharing ratio. In practice, the profit-sharing module 224 can utilize algorithms like the Shapley value for fairness standards or marginal contribution-based profit-sharing calculations and determine the profit-sharing ratios based on the contributions of the first trained or all trained model parameters.

As aforementioned, the contribution calculation module 222 excludes or simulates to exclude the at least one first trained model parameter. When the at least one first trained model parameter represents a first trained model parameter, which means simulating to exclude one federated member's participation, the individual contribution of the excluded federated member is calculated by comparing the value of the first contribution model with the federated model. On the other hand, when the at least one first trained model parameter includes a plurality of first trained model parameters, which means simultaneously excluding or simulating to exclude numerous federated members' participation, the collective contribution of the excluded federated members is calculated by comparing the first contribution model with the federated model. It should be noted that the collective contribution calculated by simultaneously excluding multiple federated members may not equal the sum of the individual contributions calculated by excluding the federated members individually.

The contribution calculation method for the federated learning contribution calculation and profit-sharing system 2 as shown in FIG. 1 includes the following steps: Step S10, the central server 22 receives a plurality of trained model parameters, which are individually generated by machine learning on numerous local datasets; Step S12, the central server 22 performs an aggregation algorithm to all trained model parameters to generate and store a federated model; Step S14, the central server 22 performs the aggregation algorithm to the remaining trained model parameters after excluding or simulating to exclude at least one first trained model parameter, so as to generate a first contribution model; and Step S16, the central server 22 compares the value of the first contribution model with the value of the federated model, so as to determine the contribution of the at least one first trained model parameter (i.e., to determine the contribution of the federated member who provided the at least one first trained model parameter).

In Step S10, the central server 22 can receive trained model parameters from multiple artificial intelligence model training devices 20, as shown in FIG. 1. In Step S12, the central server 22, through its computation module 220, performs an aggregation algorithm to assign weights to each trained model parameter and aggregates them to generate a federated model. In Step S14, the contribution calculation module 220 of the central server 22 firstly simulates to exclude at least one first trained model parameter from all trained model parameters, and then performs the aggregation algorithm to the remaining trained model parameters, excluding the at least one first trained model parameter, to obtain a first contribution model. In Step S16, the contribution calculation module 220 compares the value of the first contribution model with the value of the federated model, and determines the individual or collective contribution of the at least one first trained model parameter based on the value depreciation.

It should be noted that although the central processor is used in the aforementioned embodiment to aggregate the trained model parameters provided by the members of federated learning, in the present invention, the central processor merely represents the computing device used to aggregate and generate the federated model and the first contribution model, and is not limited to the narrow definition of a central processing unit. In practice, the central processor can be a cloud server for receiving the trained model parameters from federated members via the Internet, aggregating them into the federated model and the first contribution model, and then returning the federated model to the federated members via the Internet. Additionally, the cloud server performs the calculations mentioned previously to determine the contribution of each federated member.

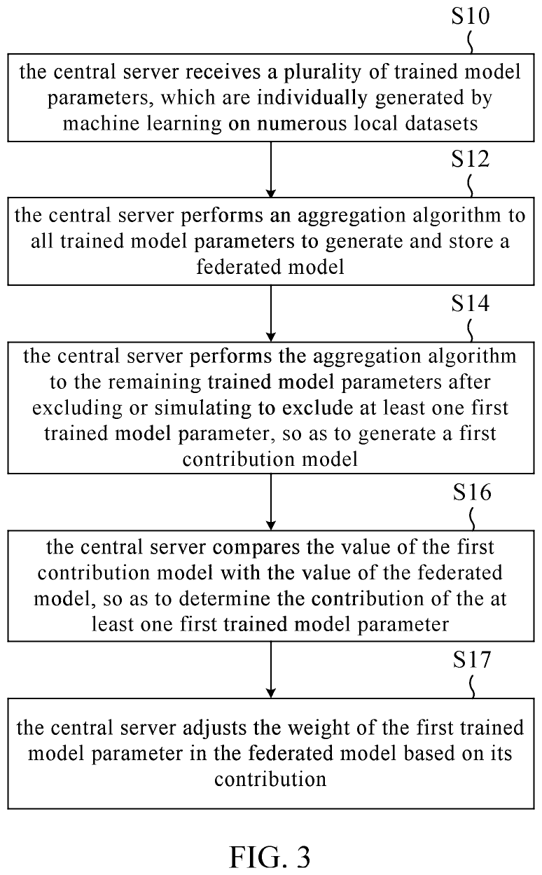

The federated learning contribution calculation and profit-sharing system 2 shown in FIG. 2 is capable of calculating individual or collective contributions of the trained modules generated by each member or multiple members within federated learning by the federated learning contribution calculation method shown in FIG. 1. Thus, based on these contributions, the profit-sharing ratios for single or multiple members can be determined. However, the calculated contributions for the trained modules can be used for purposes beyond profit-sharing. Please refer to FIG. 3. FIG. 3 is a flowchart diagram illustrating a federated learning contribution calculation method according to another embodiment of the present invention. Similarly, the steps in the method shown in FIG. 3 can be executed by different units within the system shown in FIG. 2, and then the following descriptions of the steps in FIG. 3 are also provided through the system shown in FIG. 2. As shown in FIG. 3, the difference between the present embodiment and the above-mentioned embodiment is that the method of the present embodiment further includes the following step: Step S17, the central server 22 adjusts the weight of the first trained model parameter in the federated model based on its contribution. Since contributions are determined by the value of the trained model parameters to the federated model, a trained model parameter with higher contributions has a more significant influence on the value of the federated model and vice versa. Therefore, the weights of the trained model parameters can be readjusted based on their contributions to enhance the accuracy of the federated model. It should be noted that the other steps of the present embodiment are substantially similar to those in the previously described embodiment, so they would not be described again here.

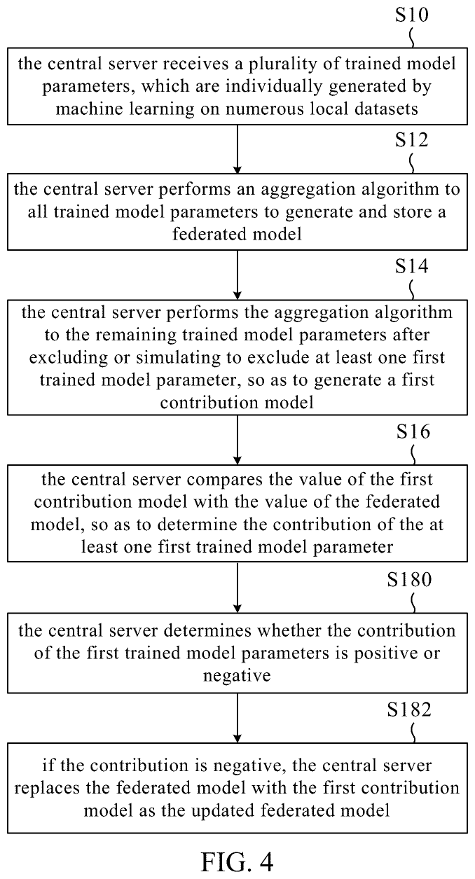

Additionally, if a trained module is calculated to have a negative contribution, it indicates that this trained module hurts the federated model and should be excluded. Please refer to FIG. 4. FIG. 4 is a flowchart diagram illustrating a federated learning contribution calculation method according to another embodiment of the present invention. The steps of the method shown in FIG. 4 can be executed by different units within the system shown in FIG. 2, and then the following descriptions of the steps in FIG. 4 are also provided through the system shown in FIG. 2. As shown in FIG. 4, the method of the present embodiment includes the following steps: Step S180, the central server 22 determines whether the contribution of the first trained model parameters is positive or negative; and Step S182, if the contribution is negative, the central server 22 replaces the federated model with the first contribution model as the updated federated model. As mentioned previously, if the contribution calculation module 222 of the central server 22 calculates that the individual or collective contribution of the at least one first trained model parameter is negative, it indicates that including the at least one first trained model parameter diminishes the value of the federated model. Therefore, the central server 22 can use the first contribution model, obtained by aggregating the remaining trained model parameters after excluding the at least one first trained model parameter, as the new federated model to ensure higher value and accuracy of the federated model.

Artificial intelligence models are typically continuously updated through training on datasets containing old and new data, and the federated learning operates similarly. In practice, each AI model training device can perform multiple rounds of machine learning on its local dataset to update its trained model. After each learning session, the resulting trained model parameters can be sent to the central server. The central server then performs an aggregation algorithm to each session's trained model parameters to generate a current federated model. For example, it might be set up so that each AI model training device (member of the federated learning system) updates its trained model every few months, and all these updated trained model parameters are then transmitted to the central server. The central server performs the aggregation algorithm on the updated trained model parameters to generate another current federated model. Therefore, based on the contribution of each trained model parameter calculated by the method above, the weights of the trained model parameters can be adjusted during the next aggregation algorithm session to generate a more optimized and accurate federated model. Additionally, if new members join the federated learning system, they can directly participate at the following machine learning training and aggregation algorithm stage.

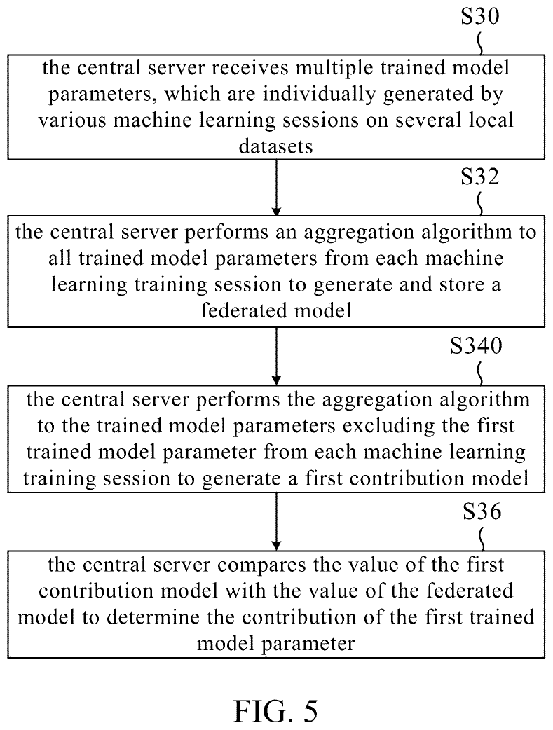

In practice, after a federated model is generated from the trained model parameters in a machine learning training stage by the aggregation algorithm, this federated model is sent back to each federated member (AI model training device). Therefore, even though each federated member use its local dataset for the following machine learning training session, this training might also be based on the updated parameters of the already completed federated model. Thus, each machine learning and aggregation algorithm stage needs to be considered when calculating the contribution of the first trained model parameter. Please refer to FIG. 5. FIG. 5 is a flowchart diagram illustrating a federated learning contribution calculation method according to another embodiment of the present invention. The steps of the method shown in FIG. 5 can be executed by different units within the system shown in FIG. 2, so the following descriptions of the steps in FIG. 5 are also provided through the system shown in FIG. 2.

As shown in FIG. 5, the method of this embodiment includes the following steps: Step S30, the central server 22 receives multiple trained model parameters, which are individually generated by various machine learning sessions on several local datasets (for example, r times); Step S32, the central server 22 performs an aggregation algorithm to all trained model parameters from each machine learning training session to generate and store a federated model; Step S340, the central server 22 performs the aggregation algorithm to the trained model parameters excluding the first trained model parameter from each machine learning training session to generate a first contribution model; and Step S36, the central server 22 compares the value of the first contribution model with the value of the federated model to determine the contribution of the first trained model parameter. In this method, the establishment of the first contribution model excludes the federated member that generated the first trained model parameters from the beginning, and the remaining members then perform all local and global calculations for all instances (r times) completely. Thus, the final first contribution model reflects the situation that the first trained model parameters did not participate in the federated learning at all, and the value difference between this model and the generated federated model indicates the contribution of the first trained model parameters. In practice, if establishing the first contribution model requires the AI model training devices 20 and the central server 22 to revert to the initial state and perform all local and global calculations thoroughly, it would significantly increase computational resource usage and costs. Therefore, the present embodiment uses a simulated exclusion approach (i.e., a simulation-based return method) to perform the calculations, which can still consume considerable computational resources and costs, especially when calculating individual contribution for each federated member.

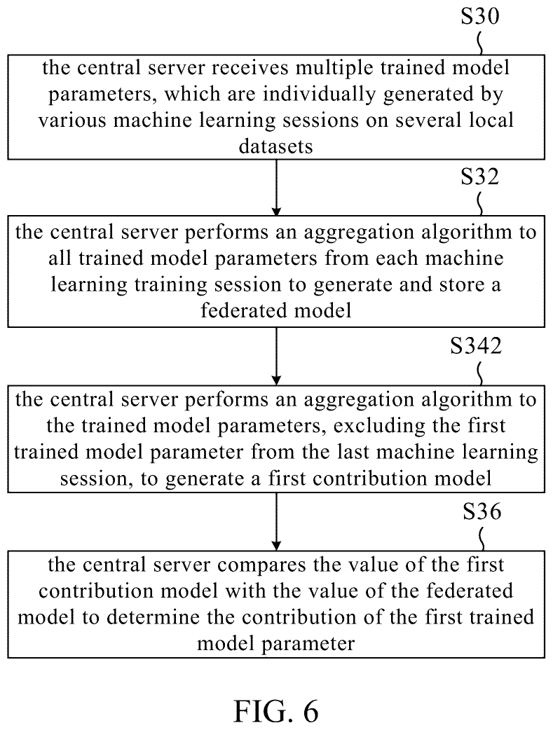

As aforementioned, although simulating to exclude the first trained model parameters from the beginning provides a contribution which is very close to the actual situation, it still consumes substantial computational resources and costs. Therefore, in practice, an appropriate level of simulating return can be determined based on the efficiency and computational performance. Please refer to FIG. 6. FIG. 6 is a flowchart diagram illustrating a federated learning contribution calculation method according to another embodiment of the present invention. The steps in the method shown in FIG. 6 can be executed by different units within the system shown in FIG. 2, so that the following descriptions of the steps in FIG. 6 are also provided through the system shown in FIG. 2. As shown in FIG. 6, the difference between the embodiment from the previous embodiments is that the method of the present embodiment further includes Step S342, the central server 22 performs an aggregation algorithm to the trained model parameters, excluding the first trained model parameter from the last machine learning session, to generate a first contribution model. In this embodiment, the central server 22 only needs to exclude the first trained model parameter from the last received trained model parameter and then perform the aggregation algorithm to obtain the first contribution model without needing the federated members to perform simulating return or undergo additional machine learning processes. Therefore, the method only requires the central server 22 to perform the aggregation algorithm one extra time, so as to consume minimal computational resources and costs. However, as each federated member continues to perform each machine learning based on the parameters of the previous federated model, the contribution calculated by excluding the first trained model parameters in the last machine learning session may slightly deviate from the actual contribution.

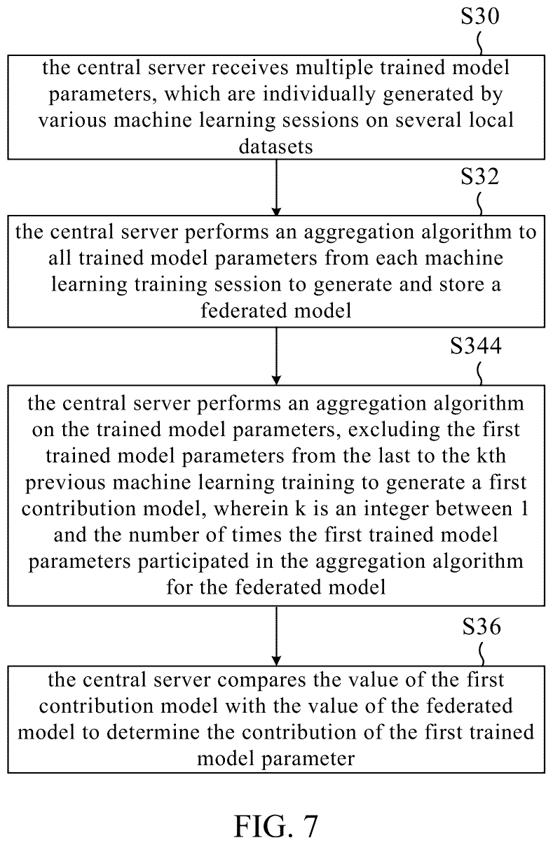

Please refer to FIG. 7. FIG. 7 is a flowchart diagram illustrating a federated learning contribution calculation method according to an embodiment of the present invention. As shown in FIG. 7, the difference between the present embodiment from the previous embodiment is that the method of the present embodiment further includes Step S344: the central server 22 performs an aggregation algorithm on the trained model parameters, excluding the first trained model parameters from the last to the kth previous machine learning training to generate a first contribution model, wherein k is an integer between 1 and the number of times the first trained model parameters participated in the aggregation algorithm for the federated model. Thus, the first contribution model is generated by excluding the first trained model parameters from their last machine learning session and simulating back k machine learning sessions through the aggregation algorithm, i.e., from the last machine learning and aggregation stage simulated back to the kth last machine learning and aggregation stage. Then, excluding the federated member that generate the first trained model parameters, the remaining federated members and the central server 22 continue to complete the remaining k machine learning and aggregation processes, and generate a first contribution model that excludes the first trained model parameters in the last k machine learning stages. The value of k can be defined based on requirements. Specifically, the closer the value of k is to the total number of the first trained model parameters involving the machine learning sessions, the closer the calculated contribution is to the actual contribution, but the more significant the computational resources and costs incur. Conversely, the closer the value of k is to 1, the less the computational resources and expenses, but the further the calculated contribution deviates from the actual contribution. It should be noted that the other steps of this embodiment are substantially similar to those in the previously embodiments and are not further described here.

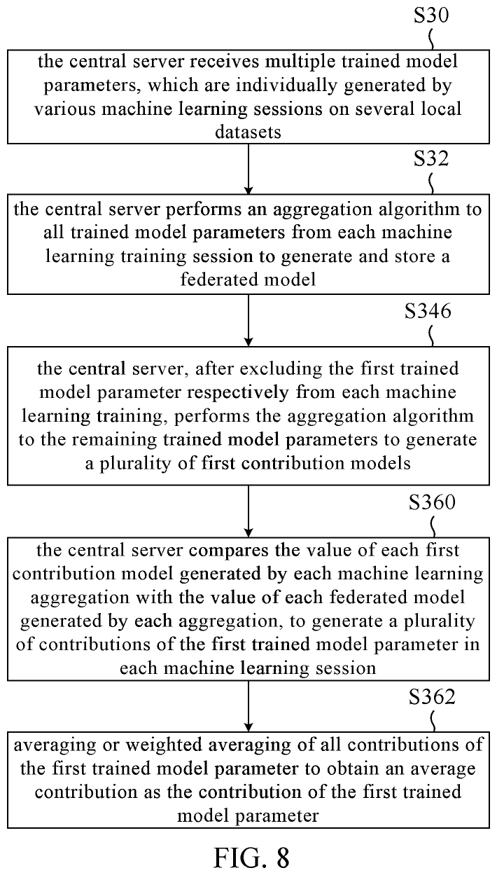

The embodiments previously mentioned disclose various methods for simulating the exclusion of the first trained model parameters, which can be chosen based on practical demand. Briefly, excluding the first trained model parameters from earlier machine learning stages results in the contributions closer to the actual contribution but consumes more computational resources and costs. However, the contribution calculation can also be approached by using averages or weighted averages to approximate the actual contribution while reducing the consumption of computational resources and costs. Please refer to FIG. 8. FIG. 8 is a flowchart diagram illustrating a federated learning contribution calculation method according to another embodiment of the present invention. The steps in the method shown in FIG. 8 can be executed by different units within the system shown in FIG. 2, and the following descriptions of the steps in FIG. 8 are also provided through the system shown in FIG. 2. As shown in FIG. 8, the method of the present embodiment includes the following steps: Step S30, the central server 22 receives a plurality of trained model parameters respectively generated by various machine learning sessions on several local datasets (for example, r times); Step S320, the central server 22 performs an aggregation algorithm to all trained model parameters respectively from each machine learning session to generate and store a plurality of federated models; Step S346, the central server 22, after excluding the first trained model parameter respectively from each machine learning training, performs the aggregation algorithm to the remaining trained model parameters to generate a plurality of first contribution models; Step S360, the central server 22 compares the value of each first contribution model generated by each machine learning aggregation with the value of each federated model generated by each aggregation, to generate a plurality of contributions of the first trained model parameter in each machine learning session; and Step S362, averaging or weighted averaging of all contributions of the first trained model parameter to obtain an average contribution as the contribution of the first trained model parameter.

In the present embodiment, after each machine learning session, the central server 22 receives and aggregates the trained model parameters to generate a federated model not only to send back to the federated members as the basis for the following machine learning session but also to store the federated models within the central server 22. Additionally, after receiving the trained model parameters from all federated members for each machine learning session, the central server 22 can directly exclude the first trained model parameters from that session and perform the aggregation algorithm to the remaining trained model parameters to generate the first contribution model for that machine learning stage. Thus, two aggregation algorithms are performed for each machine learning session to calculate the contribution of the first trained model parameter for that session. Averaging or weighted averaging of all calculated contributions then provides an average contribution of the first trained model parameter. This average contribution already considers the contribution of the first trained model parameter in each machine learning session to the federated model, thus closely approximating the actual contribution. Additionally, since all federated members in the present embodiment do not need to backtrack and redo any machine learning processes, and only an additional aggregation algorithm is required by the central server 22 at each machine learning stage, the extra computational resources and costs required for calculating the contribution are very low. There is also no need to simulate the situation that the first trained model parameter does not participate in the federated learning in each machine learning session by the simulation-based return method.

In practice, the calculation for the contributions of federated members can be achieved through the following algorithm of an embodiment. According to the present embodiment, the federated learning contribution calculation method can utilize the FedAvg algorithm to further optimize the trained model (local model) parameters after each round of machine learning to obtain a federated model (global model). In the present embodiment, the algorithm for calculating the contributions of federated members includes the following steps: define a set N formed by numerous participants and obtain the global model value of the N set by r times computations, denoted as v_{N}^{r}; set v_{N-M}^{r-k} as the model value obtained by r−k computations with removing participants in a set M from the set N; calculate v_{N}^{r}−v_{N-{i}}^{r-1} for all i∈N, wherein i represents each participant in the set N. Thereby, the marginal contribution of each participant (i.e., v_{N-{i}}^{r-1}) to the global model can be calculated. It should be noted that although the present embodiment using FedAvg for calculation, variants correspond to FedAvg, such as FedOpt, FedProx, and SCAFFOLD, can also be applied in this invention.

In this present embodiment, since v_{N}^{r} represents the model value obtained by computations on the set N, it reflects the situation that all participants are involved in federated learning. On the other hand, v_{N-M}^{r-k} represents the situation that all participants work together up to the r−k time computations of federated learning, after which the participants in the set M are excluded, and the remaining participants complete the final k computations of federated learning. The expression v_{N}^{r}−v_{N-{i}}^{r-1} represents the change in model value when the participant i is absent, and it can be defined as the marginal contribution of the participant i. The calculations described above are based on excluding either a single participant or a group of participants (|M| members) for k times participation in r times computations of federated learning, which serves as an estimate for the total marginal contribution (the situation that the single participant or the group of participants do not participate the r times computations of federated learning). The choice of k can be determined based on needs. Generally, the larger k is or the closer it is to r, the closer the calculated marginal contribution is to the actual result, but the computational costs will also correspondingly increase.

In the present embodiment, the marginal contribution of the participant i, denoted as v_{N}^{r}−v_{N-{i}}^{r-1}, represents the situation that only the last time in the r times computation of federated learning is excluded, which corresponds to the situation wherein k equals to 1. If computational performance allows, k can be freely adjusted to r, corresponding to the situation that the participant i is wholly excluded from the entire process. Therefore, the marginal contribution of the participant I, with excluding for k computations, can be calculated as v_{N}^{r}−v_{N-{i}}^{r-k}. Additionally, participant i is one of the members of set N, meaning that the algorithm for calculating marginal contributions considers only the exclusion of a single participant. If the exclusion of multiple participants in the set M is considered, the collective marginal contribution would be calculated as v_{N}^{r}−v_{N-{i}}^{r-k}. The computation for v_{N-{i}}^{r-k} retraces to the FedAvg operation at the (r−k)th computation as its initial value, and then continues with only the participants in N−M for the subsequent k computations of FedAvg. Therefore, the larger the value of k is, the higher the computational costs are required for the calculation.

In addition to the final marginal contribution calculation method by excluding a single participant or multiple participants for k computations, as mentioned above, the model value excluding the participant or the participants can also be calculated in each round of federated learning (r times). Then, the model values calculated from each round of federated learning can be averaged or weighted. The model value excluding the participant or the participants in each round of federated learning is defined as u_{N-M}^{r,j} [symbol] v_{N-M}^{j-1}, ∀j∈{1, 2, 3, . . . , r}. Then, the average value of the model excluding the participant or the participants over r computations of federated learning is 1/r×Σⱼ₌₁^{r}u_{N-M}^{r,j}, or further generalized as Σⱼ₌₁^{r}wⱼ×u_{N-M}^{r,j}, wherein wⱼ is weight factor, such as 1/r or other specific sequences like increasing, decreasing, or partially set to zero, etc. By this definition, the contributions of all participants can be more comprehensively understood from different perspectives.

In summary, the federated learning contribution calculation method and system of the present invention can calculate the contributions of the members participating in the federated learning to the federated model. Specifically, by excluding the trained model parameter generated by a member, aggregating the remaining trained model parameters into a contribution model, and comparing the value of the contribution model with the federated model, the contribution of the member and its trained model parameter can be determined. Based on the contribution calculated by this system and method, the profit-sharing ratio for the member can be determined, or the weights of the member's trained model parameter in the federated model can be adjusted based on the contribution to enhance the accuracy of the federated model. Furthermore, if a member's trained model parameter hurt the federated model, it would be indicated by the contribution calculated by this method and system to take action. For example, if it is calculated that a member's trained model parameter has a negative contribution to the federated model, the method and system of the present invention can also exclude that member and its trained model parameter to regenerate the federated model, thus eliminating the adverse influence of that member.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A federated learning contribution calculation method, comprising the steps of:
a central server receiving a plurality of trained model parameters, wherein the trained model parameters are generated by machine learning on a plurality of local datasets;
the central server performing an aggregation algorithm on the trained model parameters to generate and store a federated model;
the central server performing the aggregation algorithm on the trained model parameters, excluding or simulating to exclude at least one first trained model parameter, to generate a first contribution model; and
the central server comparing the value of the first contribution model with the value of the federated model to generate a contribution of the at least one first trained model parameter.

2. The federated learning contribution calculation method of claim 1, wherein the trained model parameters are generated by multiple machine learning training on the local datasets, the central server performs the aggregation algorithm on the trained model parameters from each machine learning training to generate the federated model, and the central server performs the aggregation algorithm on the trained model parameters, excluding the at least one first trained model parameter from the last machine learning training, to generate the first contribution model.

3. The federated learning contribution calculation method of claim 1, wherein the trained model parameters are generated by multiple machine learning training on the local datasets, the central server performs the aggregation algorithm from each machine learning training to generate the federated model, and the central server performs the aggregation algorithm on the trained model parameters, simulating to exclude the at least one first trained model parameter from each machine learning training, to generate the first contribution model.

4. The federated learning contribution calculation method of claim 1, wherein the trained model parameters are generated by multiple machine learning training on the local datasets, the central server performs the aggregation algorithm separately for each machine learning training to generate a corresponding federated model for each machine learning training, the central server performs the aggregation algorithm on the trained model parameters, excluding the at least one first trained model parameter from each machine learning training, to generate a corresponding first contribution model for each machine learning training, the central server respectively compares the value of each corresponding first contribution model with the value of each corresponding federated model for each machine learning training and performs a averaging or weighted averaging calculation to generate an average contribution as the contribution of the at least one first trained model parameter.

5. The federated learning contribution calculation method of claim 1, wherein the trained model parameters are generated by multiple machine learning training on the local datasets, the central server performs the aggregation algorithm for each machine learning training to generate the federated model, the central server performs the aggregation algorithm on the trained model parameters, simulating to exclude the at least one first trained model parameter from the last to the kth previous machine learning training, to generate the first contribution model, wherein k is an integer between 1 and the number of times the first trained model parameter participated in the aggregation algorithm of the federated model.

6. The federated learning contribution calculation method of claim 1, further comprising the steps of:
the central server judging whether the contribution of the at least one first trained model parameter is positive or negative; and
if the contribution is negative, the central server replaces the federated model with the first contribution model as an updated federated model.

7. A federated learning contribution calculation and profit-sharing system, comprising:
a plurality of artificial intelligence model training devices, configured to respectively perform machine learning on a plurality of local datasets to generate a plurality trained model parameters; and
a central server, connected to the artificial intelligence model training devices to receive the trained model parameters, the central server comprising:
a computation module, configured to perform an aggregation algorithm to the trained model parameters to generate a federated model;
a contribution calculation module connected to the computation module, configured to perform the aggregation algorithm on the trained model parameters, excluding or simulating to exclude at least one first trained model parameter, to generate a first contribution model, and configured to compare the value of the first contribution model with the value of the federated model to generate a contribution for the at least one first trained model parameter; and
a profit-sharing module connected to the contribution calculation module to receive the contribution, the profit-sharing module being configured to calculate a profit-sharing ratio for the at least one first trained model parameter in the federated model based on the contribution.

8. The federated learning contribution calculation and profit-sharing system of claim 7, wherein the artificial intelligence model training devices respectively perform multiple machine learning training on the local datasets, the computation module is configured to perform the aggregation algorithm for each machine learning training to generate the federated model, and the contribution calculation module is configured to perform the aggregation algorithm on the trained model parameters, excluding the at least one first trained model parameter from the last machine learning training, to generate the first contribution model.

9. The federated learning contribution calculation and profit-sharing system of claim 7, wherein the artificial intelligence model training devices respectively perform multiple machine learning training on the local datasets, the computation module is configured to perform the aggregation algorithm for each machine learning training to generate the federated model, and the contribution calculation module is configured to perform the aggregation algorithm on the trained model parameters, simulating to exclude the at least one first trained model parameter from each machine learning training, to generate the first contribution model.

10. The federated learning contribution calculation and profit-sharing system of claim 7, wherein the artificial intelligence model training devices respectively perform multiple machine learning training on the local datasets, the computation module is configured to perform the aggregation algorithm for each machine learning training to generate the federated model, the contribution calculation module is configured to perform the aggregation algorithm on the trained model parameters, simulating to exclude the at least one first trained model parameter from the last to the kth previous machine learning training, to generate the first contribution model, wherein k is an integer between 1 and the number of times the at least one first trained model parameter participated in the aggregation algorithm for the federated model.

11. The federated learning contribution calculation and profit-sharing system of claim 7, wherein the artificial intelligence model training devices respectively perform multiple machine learning training on the local datasets, the computation module is configured to perform the aggregation algorithm separately for each machine learning training to generate a corresponding federated model for each machine learning training, the contribution calculation module is configured to perform the aggregation algorithm on the trained model parameters, excluding the at least one first trained model parameter from each machine learning training, to generate a corresponding first contribution model for each machine-learning training, the contribution calculation module is configured to compare the value of each corresponding first contribution model with the value of each corresponding federated model from each machine learning training, and configured to perform averaging or weighted averaging calculation to generate an average contribution as the contribution of the at least one first trained model parameter.
